(19) United States
(12) Patent Application Publication
(10) Pub. No.: US 2019/0010974 A1
(43) Pub. Date: Jan. 10, 2019

(54) Anti-corrosion Elongated Sleeve for Wheel Nut or Bolt

(71) Applicant: David Hui, Taipei (TW)

(72) Inventor: David Hui, Taipei (TW)

(21) Appl. No.: 15/832,753

(22) Filed: Dec. 5, 2017

(30) Foreign Application Priority Data
Jul. 4, 2017 (TW) 106209768

(51) Int. Cl. F16B 37/14

(52) U.S. Cl. CPC F16B 37/145

(57) ABSTRACT

An elongated sleeve for anti-corrosion and decoration includes: a sleeve member having a socket formed therein; and an anti-corrosion lining member ratchetedly or irreversibly fixed in the socket of the sleeve member and operatively engaged with a wheel nut or a lug bolt secured on a wheel disk or cover, to thereby prevent corrosion between the sleeve member and the wheel nut or bolt as packed by the lining member between the nut or bolt and the sleeve member.

### BACKGROUND OF THE INVENTION

In order to decorate a wheel nut as secured on a wheel disk, an elongated sleeve made of aluminum alloy may be secured on the wheel nut for decorative purpose. However, after a long-time service, the aluminum-made sleeve may be corroded and oxidized by atmosphere moisture or pollutant. The oxidized aluminum-made sleeve may be “adhered” to the nut due to aluminum oxide produced during the atmospheric oxidation. The sleeve will not be dismantled from the nut for maintenance or replacement.

The present inventor has found the drawbacks of the conventional sleeve secured on the wheel nut, and invented the present anti-corrosion elongated sleeve for wheel nut.

### SUMMARY OF THE INVENTION

The object of the present invention is to provide an elongated sleeve for anti-corrosion and decoration including: a sleeve member having a socket formed therein; and an anti-corrosion lining member ratchetedly or irreversibly fixed in the socket of the sleeve member and operatively engaged with a wheel nut engaged on a lug bolt through a wheel disk or cover, to thereby prevent corrosion between the sleeve member and the wheel nut as packed by the lining member between the nut and the sleeve member. The wheel, nut may also be modified as a lug bolt having a sleeve with lining member engaged with the bolt.

### BRIEF DESCRIPTION OF THE DRAWINGS

FIG. 1 is a sectional drawing showing a sleeve member and a lining member of the present invention.

FIG. 2 is a perspective illustration of the present invention.

FIG. 3 is a sectional drawing showing the sleeve of the present invention secured on a wheel disk.

FIG. 4 shows another preferred embodiment of the present invention.

FIG. 5 shows still another preferred embodiment of the present invention.

### DETAILED DESCRIPTION

As shown in FIGS. 1-3, the present invention comprises: a sleeve member 1; and an anti-corrosion lining member 2 ratchetedly or irreversibly fixed or engaged in the sleeve member 1 and detachably mounted on a wheel nut N which is engaged or fastened on a lug bolt B through a wheel disk or cover W.

The sleeve member 1 may be made of aluminum alloy or other materials. The lining member 2 may be made of anti-corrosion materials including rubber, plastic, elastomer, composite or any other corrosion-resistant materials.

The sleeve member 1 includes: a polygonal or hexagonal wall 10 circumferentially formed on an outer portion of the sleeve member adapted to be fitted in a socket wrench (not shown) for driving the sleeve member 1, an upper cylindrical hole 101 formed in an upper (or outer) portion of the sleeve member 1, a socket or cylindrical socket 11 formed in a lower portion of the sleeve member 1 to be engaged with the lining member 2, an annular groove 12 annularly recessed inwardly from the socket 11 in the sleeve member 1, and a polygonal or square hole 13 formed in the sleeve member 1 at a lower portion of the upper cylindrical hole 101.

The lining member 2 includes: a polygonal or hexagonal hole 21 formed in the lining member 2 to be detachably engaged with the wheel nut N mounted on the wheel disk or cover W, a plurality of ratchet teeth 22 circumferentially formed on an outer periphery of the lining member 2 to be ratchetedly or irreversibly fastened into the annular groove 12 annularly recessed in the sleeve member 1, and a top polygonal or square extension 23 formed on a top portion of the lining member 2 to be snugly engaged with the polygonal or square hole 13 formed in the sleeve member 1.

When assembling, the lining member 2 is engaged into the socket 11 in the sleeve member 1 by engaging the ratchet teeth 22 of the lining member 2 with the annular groove 12 of the sleeve member 1. Since the ratchet teeth 22, once engaged within the annular groove 12 of the sleeve member 1, will not be reversibly retracted or dismantled from the sleeve member 1 to thereby stably engage the lining member 2 within the sleeve member 1. So, the lining, member 2 is ratchetedly or irreversibly engaged with the sleeve member 1 for a stable connection.

The top polygonal (or square) extension 23 of the lining member 2 is snugly engaged with the polygonal (or square) hole 13 in the sleeve member 1, so that the lining member 2 will be cooperatively rotated with the sleeve member 1 once being rotated such as by a socket wrench when fitted on the polygonal wall 10 of the sleeve member 1. Upon rotation of the sleeve member 1, the lining, member 2 will be cooperatively rotated to rotate the wheel nut N as held in the lining member 2, thereby fastening (or unfastening) the nut N with a lug bolt B on the wheel disk or cover W.

The present invention provides an anti-corrosion lining member 2 to be sandwiched in between the wheel nut N and the sleeve member 1 so that the sleeve member 1 will not be directly contacted with the wheel nut N. Once the sleeve member 1, such as made of aluminum alloy, is corroded, the oxidation between the sleeve member 1 and the nut N will be precluded or “insulated” by the lining member 2 as sandwiched between the nut and the sleeve member. Therefore, the sleeve consisting of the sleeve member 1 and the lining member 2 of the present invention may be easily detached from the nut N for a smooth maintenance or replacement.

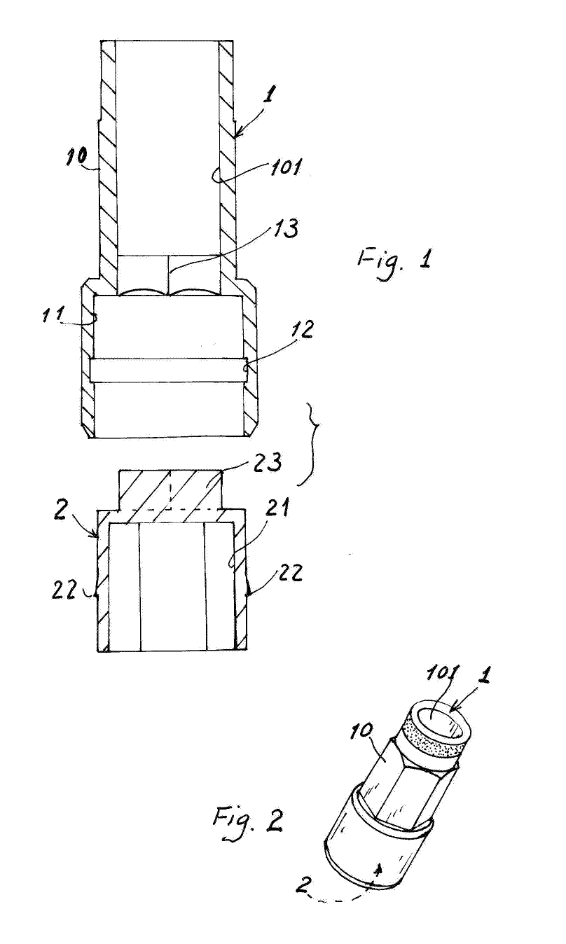

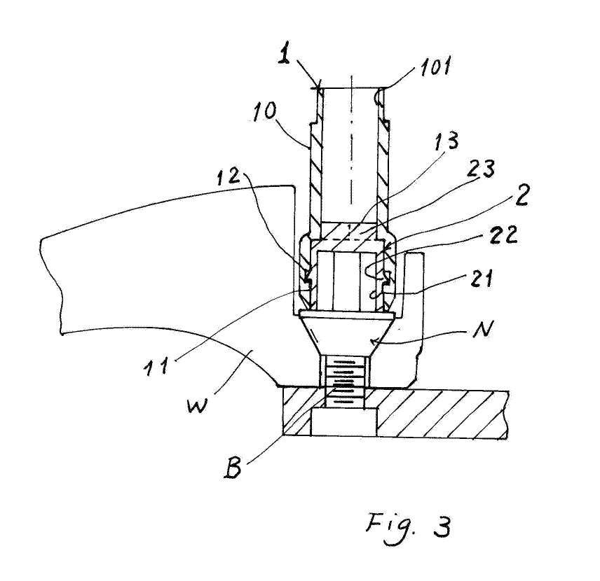

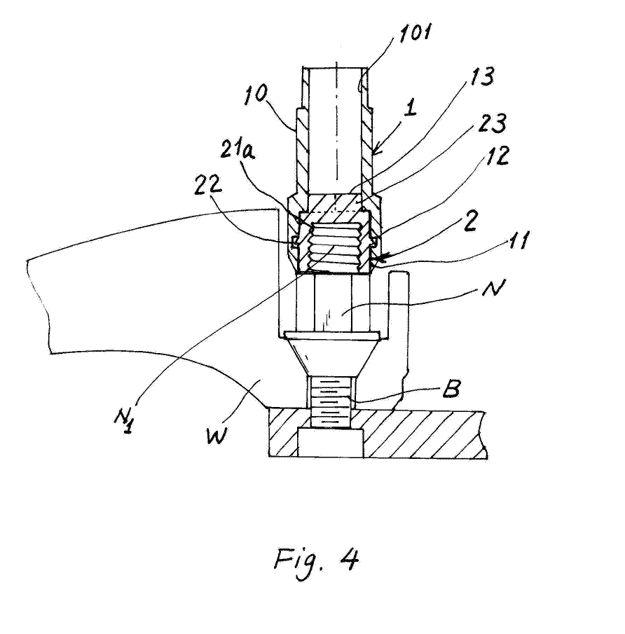

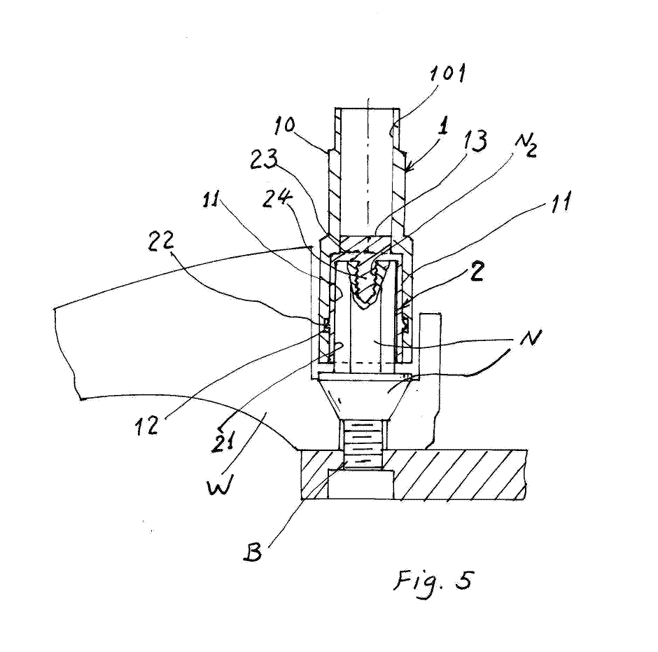

As shown in FIG. 4, the lining member 2 is formed with a female-threaded hole 21a therein, adapted to be engaged with a male-threaded portion N1 formed on the wheel nut N. Upon rotation of the sleeve consisting of the sleeve member 1 and the lining member 2, the sleeve will be rotatably fastened on the nut N. For rotating the sleeve member 1, it may be driven by a wrench tool (not shown).

As shown in FIG. 5, the lining member 2 is formed with a male-threaded plug 24, adapted to be engaged with a female-threaded hole N2 formed in an upper portion of the nut N, so that the sleeve may be fastened on the nut by rotating the sleeve member 1 and the lining member 2 as engaged with the sleeve member 1.

The above-mentioned wheel nut N may be modified to be a lug bolt. Then, a sleeve member as lined with a lining member is engaged with a bolt head of the lug bolt to fix a decorative elongated sleeve on the bolt (not shown).

The sleeve member 1 may also be modified to enlarge the polygonal wall 10 from an upper portion towards a bottom of the sleeve member.

The present invention may be further modified without departing from the spirit and scope of the present invention. The lining member 2 may be fixed in the sleeve member 1 by adhesive for firmly bonding the lining member 2 in the sleeve member 1.

I claim:

1. A sleeve for wheel nut or bolt comprising:
a sleeve member; and
an anti-corrosion lining member ratchetedly or irreversibly engaged in said sleeve member, said lining member engageable with a wheel nut or bolt;
whereby upon engaging of said sleeve on said wheel nut or bolt, said lining member is sandwiched between said wheel nut or bolt and said sleeve member to preclude contact of said sleeve member from said nut or bolt to prevent from adhesion of said sleeve member with said nut or bolt due to corrosion or oxidation of said sleeve member.

2. A sleeve according to claim 1, wherein said anti-corrosion lining member is made of elastomer, plastic, rubber, and composite, having anti-corrosion property.

3. A sleeve according to claim 1, wherein sleeve member includes an upper cylindrical hole formed in an upper portion of the sleeve member, a socket formed in a lower portion of said sleeve member to be engaged with said lining member, an annular groove annularly recessed in the sleeve member as inwardly recessed from said socket in said sleeve member, and a polygonal hole formed in a lower portion of said upper cylindrical hole.

4. A sleeve according to claim 1, wherein said lining member includes a polygonal hole formed in said lining member to be detachably engaged with said wheel nut or bolt, a plurality of ratchet teeth circumferentially formed on an outer periphery of said lining member to be ratchetedly or irreversibly fastened into an annular groove as annularly recessed in said sleeve member, and a top polygonal extension formed on a top portion of said lining member to be snugly engaged with the polygonal hole in said sleeve member.

5. A sleeve according to claim 4, wherein said top polygonal extension of said lining member includes a top square extension, and said polygonal hole in said sleeve member is a square hole to be engaged with said top square extension of said lining member.

6. A sleeve according to claim 1, wherein said lining, member further includes a female-threaded hole formed in said lining member, adapted to be engaged with a male-threaded portion formed on said wheel nut or bolt.

7. A sleeve according to claim 1, wherein said lining member further includes a male-threaded plug formed in said lining member, adapted to be engaged with a female-threaded hole formed in said wheel nut or bolt.

8. A sleeve according to claim 1, wherein said sleeve member further includes a polygonal wall circumferentially formed on a periphery of said sleeve member, adapted to be fitted with a socket wrench for rotatably driving said sleeve member and said lining member for fastening said wheel nut or bolt.

9. A sleeve according to claim 1, wherein said lining member is fixed in said sleeve member by adhesive bonding.
